(19) United States
(12) Patent Application Publication
(10) Pub. No.: US 2026/0044484 A1
(43) Pub. Date: Feb. 12, 2026

(54) SYSTEM AND METHODS OF EFFICIENT AND DECOUPLED OPERATION LOG MANAGEMENT FOR KEY-VALUE DATABASE SYSTEMS

(71) Applicant: HUAWEI CLOUD COMPUTING TECHNOLOGIES CO., LTD., Guizhou (CN)

(72) Inventors: Karthick Ariyaratnam, Ottawa (CA); Syed Saad Naseem, Ottawa (CA); Kajaruban Surendran, Ottawa (CA); Heng Kuang, Ottawa (CA); Lucas Guang Yang, Ottawa (CA); Guoyao Li, Ottawa (CA)

(21) Appl. No.: 18/799,916

(22) Filed: Aug. 9, 2024

(51) Int. Cl. G06F 16/22; G06F 11/14

(52) U.S. Cl. CPC G06F 16/2255; G06F 11/1469; G06F 2201/80

(57) ABSTRACT

Disclosed herein are methods of managing an operation log using an operation log management service that is decoupled from the core service of a key-value database. The decoupled operation log management service receives operation data from a key-value database, processes the operation data thereby generating operation information, and records the operation data and the operation information to the operation log. The decoupled operation log management service allows the core service to focus on core service logic. Also disclosed are methods of concurrently managing operation data using a plurality of threads at an operation log management service. The concurrent data management method resolves data collisions using a hash table. Non-transitory, computer-readable storage media comprising computer-executable instructions, cause a processor, processing unit, or circuit to perform the methods disclosed herein. Systems comprising one or more processors are also capable of performing the methods disclosed herein.

### TECHNICAL FIELD

The present invention relates to key-value database technology. In particular, the inventions disclosed herein relate to efficient decoupled operation log management systems for key-value databases and methods of using the same.

### BACKGROUND

Key-value databases are a paradigm for storing, retrieving, and managing associative arrays. Most of the present key-value database systems can generate an operation log which provides a historical data source of operations executed on the data within the key-value database. In particular, present key-value database systems comprise a core service for executing operations on data within the key-value database and an operation log management service for managing and logging operation data and operation information associated with the operation data to the operation log. The operation log plays an important role in database recovery, database replication, and database monitoring.

In present key-value database systems, the core service and operation log management service are tightly coupled, meaning the services share memory resources and are usually executed by the same processor or group of processors. Due to this strong coupling, resources that could be used by the core service to improve efficiency of the key-value database system are instead diverted to the operation log management service. Accordingly, present key-value database systems face many challenges including but not limited to performance degradation, disk IO overhead, and resource consumption. The disadvantages and challenges arising from key-value database systems because of tightly coupled core and operation log management services become even more apparent as database operations increase and demand for faster database performance increases.

Accordingly, there is a need to reduce performance bottlenecks caused by the operation log management service. There is also a need for a light-weight operation log management service that allows the core service to solely focus on executing business logic. There is a further need for improving the overall performance and scalability of key-value database systems to reduce resource consumption and save cost.

### SUMMARY

Embodiments of this disclosure relate to systems, apparatuses, methods, and non-transitory computer-readable storage devices employing an operation log management service that is decoupled from the core service of a key-value database.

According to one aspect of this disclosure, there is provided a first method of managing an operation log using a service that is decoupled from a first key-value database, the method comprising: receiving operation data at the service from the first key-value database; processing the operation data by the service thereby generating operation information; and recording the operation data and the operation information to the operation log using the service.

In an embodiment, the service in the first method receives the operation data in the form of a plurality of data chunks.

In an embodiment, the first key-value database in the first method is a key-value store or a key-value cache.

In an embodiment, the first key-value database in the first method comprises a key-value store and a key-value cache.

In an embodiment, the first method further comprises the step of transmitting the operation data from the service to the first key-value database for restoring the first key-value database to a first point-in-time.

In an embodiment, the service in the first method receives operation data via a communication link using transmission control protocol, an application programming interface, or hypertext transfer protocol secure.

In an embodiment, the operation information generated in the first method includes metadata details of operations executed on key-value data stored within the first key-value database, including operation id, timestamp, version, cluster id, shard id, and slot id.

In an embodiment, the first method further comprises the step of executing compaction, compression, archive, or purge operations on the operation log using the service.

In an embodiment, the first method further comprises the step of storing the operation information at the service.

In an embodiment, the first key-value database in the first method is configured to communicate with a second key-value database.

In an embodiment, the first method further comprises the step of transmitting the operation data from the service to the second key-value database for restoring the second key-value database to a second point-in-time.

In an embodiment, the second key-value database in the first method is maintained as a backup of the first key-value database.

In an embodiment, the service in the first method comprises a unified interface for transmitting the operation data to the first key-value database and to the second key-value database to allow restoration of the first key-value database to a first point-in-time and to allow restoration of the second key-value database to a second point-in-time.

According to one aspect of this disclosure, there is provided one or more circuits such as one or more processors for performing any embodiment of the above-described first method.

According to one aspect of this disclosure, there is provided one or more processors functionally connected to one or more memories for performing any embodiment of the above-described first method.

According to one aspect of this disclosure, there is provided an apparatus comprising: one or more processors functionally connected to one or more memories for performing any embodiment of the above-described first method.

According to one aspect of this disclosure, there is provided a system comprising one or more processors functionally connected to one or more memories storing instructions, and the one or more processors is configured to execute the instructions and cause the system to perform any embodiment of the above-described first method.

According to one aspect of this disclosure, there is provided one or more non-transitory computer-readable storage media comprising computer-executable instructions, wherein the instructions, when executed, cause at least one processing unit, at least one processor, or at least one circuit to perform any embodiment of the above-described first method.

According to one aspect of this disclosure, there is provided a second method of concurrently managing operation data using a service decoupled from a key-value database, the second method comprising: receiving operation data in the form of a plurality of data chunks at the service from the key-value database; reading the data chunks at the service using a plurality of reader threads; incorporating the operation data in each data chunk in a merged data buffer and into a hash table, the hash table comprising a plurality of key-value data pairs, each key-value data pair comprising a key, a value associated with at least part of the operation data, and a hash value; recording, in a collision list, the associated key of a given key-value pair that has the same hash value as another key-value pair; re-ordering the operation data associated with the value of each key in the collision list to the end of the merged data buffer; processing the operation data in the merged data buffer, wherein the re-ordered operation data associated with key-value pairs having the same hash value is processed using a single processing thread, and wherein the processing generates operation information; and recording the operation data and operation information to an operation log.

In some embodiments, the second method further comprises the step of processing the re-ordered operation data associated with key-value pairs having different hash values using a plurality of processing threads.

According to one aspect of this disclosure, there is provided one or more circuits such as one or more processors for performing any embodiment of the above-described second method.

According to one aspect of this disclosure, there is provided one or more processors functionally connected to one or more memories for performing any embodiment of the above-described second method.

According to one aspect of this disclosure, there is provided an apparatus comprising: one or more processors functionally connected to one or more memories for performing any embodiment of the above-described second method.

According to one aspect of this disclosure, there is provided a system comprising one or more processors functionally connected to one or more memories storing instructions, and the one or more processors is configured to execute the instructions and cause the system to perform any embodiment of the above-described second method.

According to one aspect of this disclosure, there is provided one or more non-transitory computer-readable storage media comprising computer-executable instructions, wherein the instructions, when executed, cause at least one processing unit, at least one processor, or at least one circuit to perform any embodiment of the above-described second method.

According to one aspect of this disclosure, there is provided an apparatus, and configured to perform the any one of the above-mentioned methods and their embodiments. Specifically, the apparatus includes one or more units configured to perform the any one of the above-mentioned methods and their embodiments.

According to one aspect of this disclosure, there is provided a computer-readable storage medium. The computer-readable storage medium stores a computer program, and when the computer program is executed by an apparatus, the apparatus is enabled to implement the any one the of above-mentioned methods and their embodiments.

According to one aspect of this disclosure, there is provided a computer program product including one or more instructions. When the instructions are executed by an apparatus such as a computer, the apparatus is enabled to implement the any one of the above-mentioned methods and their embodiments.

According to one aspect of this disclosure, there is provided a computer program. When the computer program is executed by a computer, an apparatus is enabled to implement the any one of the above-mentioned methods and their embodiments.

According to one aspect of this disclosure, there is provided an apparatus for implementing the method in any possible implementation of the foregoing aspects.

With above-described features, the methods disclosed herein may allow greater efficiencies in key-value database technologies.

### BRIEF DESCRIPTION OF DRAWINGS

Specific embodiments of the invention will now be described with reference to the following drawings, which are provided by way of example, and not intended to limit the invention.

FIG. 1 is a schematic block diagram of a key-value database system according to an embodiment of the invention.

FIG. 2 is a schematic block diagram of an operation log management system according to an embodiment of the invention.

FIG. 3 is a flow chart illustrating a method of concurrently managing operation data using an operation log management service according to an embodiment of the invention.

FIG. 4 is a schematic diagram of a key-value database system interacting with user devices according to an embodiment of the invention.

### DETAILED DESCRIPTION

The key-value database systems disclosed herein comprise at least one key value database comprising a core service, an operation log management service decoupled from the core service, and an operation log.

In an embodiment, the disclosed operation log management systems comprise an operation log and an operation log management service that is decoupled from the core service of a key-value database.

Also disclosed herein are methods of managing an operation log using an operation log management service decoupled from the core service of a key-value database and methods of concurrently receiving operation data at an operation log management service from a decoupled core service of a key-value database.

The disclosed operation log management systems can perform operation log specific logic as a standalone service (i.e. separate from the core service). Exemplary operation log specific logic includes generating operation information from the operation data, recording operation data and operation information to an operation log, managing the operation log, and reading operation data and operation information from the operation log. The operation log may comprise one or more files and is not limited to any particular file type.

The decoupled operation log management service disclosed herein enables separate service providers, operating separate businesses, to provide the core and operation log management services. By decoupling (i.e. separating) the core and operation log management services, the resource consumption of each service may be monitored allowing custom scalability and maintenance of each service as needed.

Embodiments of the present operation log management systems may allow third-party tools to connect to the operation log management service to monitor and analyze the operation log logic without impacting performance of the core service.

The key-value database systems disclosed herein comprising decoupled core and operation log management services can improve performance of the core service by offloading logic relating to the management of the operation log to the operation log management service. This enables the core service to dedicate more resources to the business logic relating to operations executed on the data within the database. For example, the disclosed operation log management system can reduce CPU time and memory consumption of the decoupled core service, allowing the core service respond more rapidly to client demands.

In some embodiments, the key-value database system comprises a first key-value database and a second key-value database. In some embodiments the first key-value database is primary key-value database comprising primary data in key-value format. The core service of the primary key-value database executes operations on the primary data, thereby generating operation data. In some embodiments the second key-value database is a replica key-value database which is maintained as a backup of the first key-value database.

In an embodiment, the decoupled operation log management service eliminates the need for duplicate operation log management logic in both the primary and replica key-value databases thereby reducing the collective storage demand of the key-value database system.

In an embodiment, the decoupled operation log management service improves the response time of the replica key-value database during replication of the primary key-value database from the replica key-value database.

As compared to traditional key-value database systems comprising tightly coupled core and operation log management services, the core service of key-value database systems disclosed herein may perform less disk IO operations. Therefore, a performance improvement may be realized over traditional systems with the key-value database systems disclosed herein. This performance improvement may be observable by monitoring CPU and memory usage.

In an embodiment, a communication link enables communication between the core service and decoupled operation log management service. Among other functions, the communication link permits transmission of operation data from the core service to the operation log management service. In other words, the operation log management service receives operation data from a key-value database over the communication link.

In an embodiment, the disclosed operation log management systems operate in the cloud. In cloud environments, depending on the architecture of the key-value database system and other variables, there may be a period of latency in the transmission of operation data from the core service to the decoupled operation log management service.

To decrease latency and further improve the disclosed key-value database systems, in a preferred embodiment, the core service uses multiple sender threads to transmit operation data in the form of a plurality of data chunks over the communication link to the decoupled operation log management service, which receives the data chunks and reads the data chunks using a plurality reader threads. In a preferred embodiment, the decoupled operation log management service transmits operation data and operation information to a key-value database using a plurality of threads.

Embodiments of key-value database systems comprising multi-threaded transmission of operation data can result in improved performance in the data propagation aspect of the disclosed systems.

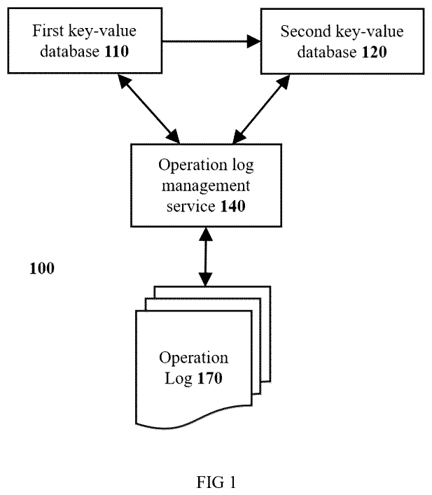

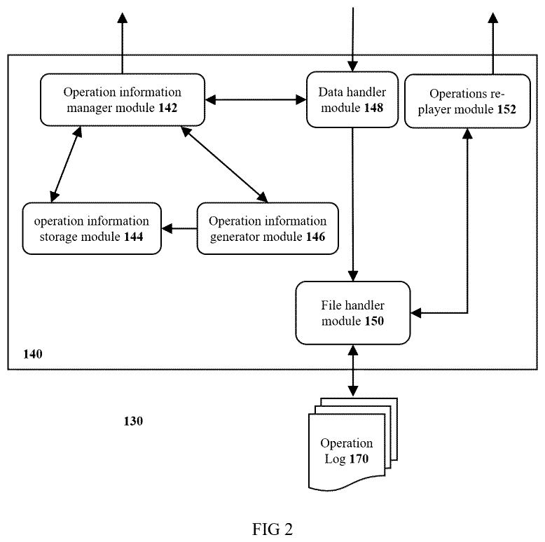

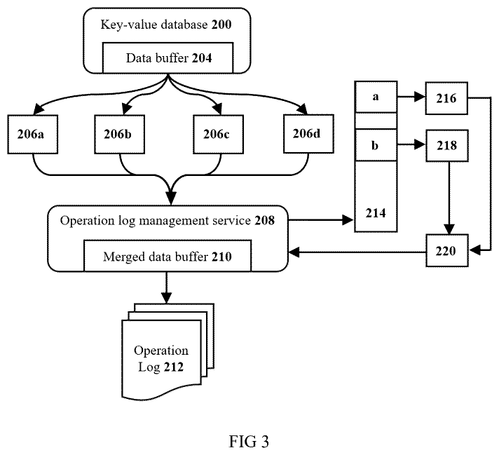

The invention will now be described with reference to FIG. 1 which shows a schematic block diagram of an embodiment of a key-value database system 100 disclosed herein. As a preliminary note, FIG. 1, FIG. 2, and FIG. 3 are simplified illustrations of the invention disclosed herein which are not intended to limit the disclosed invention. Furthermore, the arrows shown in FIG. 1, FIG. 2, and FIG. 3, are intended to show the flow of data/information but they are in no way intended to limit the invention disclosed herein.

As shown in FIG. 1, key-value database system 100 comprises a first key-value database 110 for storing primary data in key-value format, a second key-value database 120 for storing secondary data in key-value format, an operation log management service 140, and an operation log 170.

The first key-value database 110 comprises a core service with one or more core service processors for executing operations on the primary data thereby generating the operation data. For example, the operations may be the get command, put command, delete command, or update command. However, other operations exist as well as variations to these operations. Operation data is a representation of one or more operations executed by the core service on data within a key-value database.

In certain embodiments, the first key-value database 110 is a key-value store. In other embodiments, the first key-value database 110 is a key-value cache. In yet other embodiments, the first key-value database 110 comprises a key-value store and a key-value cache.

The operation log 170 and operation log management service 140 form part of an operation log management system which is decoupled from the core service of the first key-value database 110. In other words, the operation log management service 140 and core service are separate services with their own memory and CPUs.

A communication link enables the exchange of data/information between the core service of the first key-value database 110 and the operation log service 140. Accordingly, the communication link permits the core service of the first key-value database 110 to propagate operation data to the decoupled operation log service 140. In other words, the operation log management service 140 receives operation data from a first key-value database via the communication link. In an embodiment, the core service of the first key-value database 110 comprises a cache and operation data in the cache is propagated the decoupled operation log service 140.

The operation log management service 140 comprises one or more operation log management processors configured to generate operation information from the operation data. Operation information may include metadata details of each operation, for example, operation id, timestamp, version, cluster id, shard id, slot id, etc. The one or more operation log management processors record the operation data and operation information in the operation log 170. The operation log management service 140 may comprise a cache for storing a temporary amount of operation data and operation information. The operation data and operation information in the cache of the operation log management service 140 may be periodically flushed to the operation log 170. In a preferred embodiment, the flush frequency of the operation log management system is configurable.

In a preferred embodiment, the core service comprises a plurality of sender threads for sending operation data divided into a plurality of data chunks over the communication link and the operation log management service 140 is configured to receive the plurality of data chunks and read the plurality of data chunks using a plurality of reader threads.

When the operation log 170 grows in size, the one or more operation log management processors of the operation log management service 140 are capable of executing compaction, compression, archive, or purge operations on the operation log 170. Since the operation log management service 140 is decoupled from the core service, the core service resources are not burdened by the operation log logic performed by the one or more operation log management processors. This reduces disk IO overhead on the core service and enables the core service to respond more quickly to client demands.

In an embodiment, the decoupled operation log management service 140 can retrieve operation data from the operation log 170 and transmit the operation data, via the communication link, to the first key-value database 110. The first key-value database 110 can re-play certain operations specified in the operation data sent by the decoupled operation log management service 140 to restore the first key-value database 110 to a desired point-in-time. For example, it may be desirable for the first key-value database 110 to re-play operations specified in the operation data for purposes of disaster recovery.

In an embodiment, the key-value database system 100 comprises a second key-value database 120. The second key-value database 120 may be maintained as a backup of the first key-value database 110. For example, the second key-value database 120 may be replica key-value database of the first key-value database 110. The second key-value database 120 may be configured to communicate with the first key-value database 110. In an embodiment, the key-value database system 100 comprises two or more replica key-value databases.

In an embodiment, the first key-value database 110 may propagate operation data to the second key-value database 120. The second key-value database 120 can re-play certain operations specified in the operation data to restore the second key-value database 120 to a desired point-in-time.

In an embodiment, the operation log management service 140 comprises a unified interface for transmitting operation data to the first key-value database 110 and to the second key-value database 120. The first key-value database 110 and second key-value database 120 may re-play operations specified in the operation data to be restored to desired points-in-time.

The unified interface may allow the first key-value database 110 and second key-value database 120 to re-play operations independently of one another. In other words, the second key-value database 120 does not require participation from the first key-value database 110 in the restoration process of the second key-value database 120. Likewise, the first key-value database 110 does not require participation from the second key-value database 120 in the restoration process of the first key-value database 110. The unified interface may transmit operation data to a key-value database based on operation information received from a key-value database.

The first key-value database 110 may communicate with the decoupled operation log service 140 through a variety of communication protocols. For example, communication may be enabled via transmission control protocol, restful application programming interface, hypertext transfer protocol secure with various data formats, such as, I/O stream, JSON, extensible markup language (XML), etc. Likewise, the second key-value database 120 may communicate with the decoupled operation log service 140 through a variety of communication protocols. The first key-value database 110 and second key-value database 120 may communicate through a variety of communication protocols as well. The invention described herein is not intended to be limited by the communication protocols or means of communication between the various components of the key-value database system 100.

Furthermore, the invention disclosed herein is not intended to be limited to any particular type of key-value database. The only requirement of the disclosed key-value database systems is a core service decoupled from the operation log management service. In some embodiments, the key-value database may comprise a built-in operation log management service in addition to a decoupled operation log management service.

The invention will now be described with reference to FIG. 2 which shows a schematic block diagram of an embodiment of an operation log management system 130 disclosed herein. As shown in FIG. 2, operation log management system 130 comprises operation log management service 140 and operation log 170. Operation log management system 130 is operable within a key-value database system comprising at least a first key-value database. The first key-value database comprises a core service which is decoupled from the operation log management system 130. Due to this decoupling, operation log management system 130 may be provided as a stand-alone service separate from the core service.

As in FIG. 1, the operation log management service 140 shown in FIG. 2 receives operation data from the core service of a key-value database in relation to operations executed on data within the key-value database. The operation log management service 140 generates operation information from the operation data, records operation data and operation information to the operation log 170, manages the operation log 170 (for example, by executing compaction, compression, archive, or purge operations on the operation log 170), transmits operation information to a first key-value database, and transmits operation data to one or key-value databases to enable one or more key-value databases to re-play operations specified in the operation data thereby restoring the one or more key-value databases to a desired point-in-time.

FIG. 2 shows a particular architecture of an operation log management service 140 that is not intended to limit the invention as a whole. As shown in FIG. 2, operation log management service 140 comprises an operation information manager module 142, an operation information storage module 144, an operation information generator module 146, a data handler module 148, a file handler module 150, and an operations re-player module 152. These modules may be specific software components of the operation log management service 140.

In an embodiment, data handler module 148 received operation data from the core service of a key-value database. In preferred embodiments, data handler module 148 comprises multiple reader threads and receives operation data in a plurality of data chunks and uses the reader threads to read the plurality of data chunks. Data handler module 148 is configured to communicate with the operation information manager module 142 and the file handler module 150. Data handler module 148 transmits operation data to the operation information manager module 142.

In an embodiment, operation information manager module 142 receives operation data from the data handler module 148 and transmits operation data to the operation information generator module 146. The operation information generator module 146 processes the operation data to generate operation information associated with the operation data. The operation information may include the metadata details of each operation, for example, operation id, timestamp, version, cluster id, shard id, slot id, etc. The operation information is stored by the operation information storage module 144.

In an embodiment, operation information manager module 142 can retrieve operation information from the operation information storage module 144 and/or the operation information generator module 146. The operation information manager module 142 can transmit the retrieved operation information to the core service of a key-value database and to the data handler module 148 of the operation log management service 140.

In an embodiment, data handler module 148 can transmit operation data and operation information to the file handler module 150, which writes the operation data and operation information to the operation log 170. File handler module 150 may comprise a cache for temporarily storing operation data and operation information and may flush the cache (i.e. write the contents of the cache) to the operation log 170 at certain time points and/or when the cache has reached a certain capacity. Preferably, the flush frequency is user configurable.

In an embodiment, file handler module 150 is capable of executing operation log management logic on the operation log 170. For example, file handler module 150 may execute compaction, compression, archive, and/or purge operations on the operation log 170 based on specialized metadata in the operation information stored in the operation log 170, such as idempotence, state, database id, compression id, etc. In a further embodiment, file handler module 150 provides an interface for accessing operation data and operation information stored in the operation log 170, for example, for re-playing operations at a key-value database.

In an embodiment, operations re-player module 152 can receive operation information from a key-value database and obtain operation data associated with the operation information from the operation log 170 via the file handler module 150. For example, a key-value database may send an operation id to the operations re-player module 152 and the operations re-player module may retrieve operation data associated with the operation id and transmit the operation data to the key-value database.

In an embodiment, operations re-player module 152 comprises an interface to communicate with one or more key-value databases. In particular, operations re-player module 152 allows one or more key-value databases to re-play the operations specified in the operation data. Preferably, the interface is a unified interface that allows multiple key-value databases to simultaneously re-play operations specified in the operation data retrieved by the operations re-player module 152. A key-value database may re-play operations during disaster recovery to restore the key-value database to a desired point-in-time.

In an embodiment, the operations re-player module 152 receives an operation id from a key-value database, retrieves operation data associated with the operation id from the operation log 170, and transmits the operation data to the key-value database to enable operation id based point-in-time recovery.

Various methods of operating the systems disclosed herein will now be described. In an embodiment, provided herein are methods of managing an operation log of a key-value database system. The key-value database system comprises a first key-value database for storing primary data in key-value format, a core service, an operation log management service decoupled from the core service, and a communication link. For example, in an embodiment, operation log management service and core service are separately operated by independent service providers and the operation log management service is able to connect to, and communicate with, the first key-value database.

The methods of managing the operation log of the key-value database system comprises the step of receiving operation data via the communication link at the operation log management service, wherein the operation data was generated by one or more core service processors of the core service by executing operations on the primary data in the first key-value database. For example, in an embodiment, the operation log management service may receive operation data via the communication link using transmission control protocol, an application programming interface, or hypertext transfer protocol secure.

The methods of managing the operation log of the key-value database system disclosed herein further comprise the step of processing the operation data by one or more operation log management processors of the operation log management service thereby generating operation information. For example, in an embodiment, the operation information includes metadata details of the operations executed by the one or more core service processors of the core service, including operation id, timestamp, version, cluster id, shard id, and slot id.

The methods of managing the operation log of the key-value database system disclosed herein further comprise the step recording the operation data and operation information to the operation log using the one or more operation log management processors.

Other steps may be performed in addition to the steps noted above without departing from the scope of the methods disclosed herein. For example, in an embodiment, the method further comprises the step of executing compaction, compression, archive, and/or purge operations on the operation information recorded in the operation log using the one or more operation log management processors.

In an embodiment, the method further comprises the step of transmitting operation data from to operation log management service to the first key-value database for restoring the first key-value database to a first point-in-time.

In another embodiment, the key-value database system further comprises a second key-value database for storing secondary data in key-value format, and the method further comprising the step of transmitting operation data from to operation log management service to the second key-value database for restoring the second key-value database to a second point-in-time. In a further embodiment, the operation log management system further comprises a unified interface for transmitting operation data to the first key-value database and to the second key-value database to allow restoration of the first key-value database to a first point-in-time. The first and second key-value databases can receive the operation data and re-play operations specified in the operation data thereby restoring the key-value databases to desired points-in-time. For example, the unified interface may allow the first and second key-value databases to re-play operations independently of one another.

The methods disclosed herein will now be described with reference to FIG. 3 which shows a flow chart illustrating a method of concurrently managing operation data using an operation log management service according to an embodiment of the invention. As shown in FIG. 3, key-value data base 202 and operation log management system (comprising and operation log management service 208 and operation log 212) form part of a key-value database system 200.

Key-value data base 202 is configured to store at least some data in key-value format. Key-value data base 202 comprises a core service configured to perform operations on the key-value data stored in the key-value data base 202 thereby generating operation data. Like previously described embodiments of the present invention, the operation log management service 208 is decoupled from the core service of the key-value data base 202. For example, in an embodiment, operation log management service 208 and core service are separately operated by independent service providers and the operation log management service is able to connect to, and communicate with, the key-value database 202. In another embodiment, operation log management service 208 and core service are operated by the same service provider on separate resources (i.e. the operation log management service 208 and core service each have their own processors and memory resources).

As shown in FIG. 3, key-value database 202 comprises data buffer 204 wherein operation data is stored before being transmitted to the operation log management service 208. Data buffer 204 may form part of the read-only memory, cache memory, random access memory, virtual memory, or other types of memory of key-value database 202.

The operation data in data buffer 204 is divided into data chunks. In the embodiment shown in FIG. 3, the operation data is divided into a first data chunk 206a, a second data chunk 206b, a third data chunk 206c, and a fourth data chunk 206d. Other embodiments may divide the operation data in two, three, or more than four data chunks. In an embodiment, a unique chunk-id is associated with each data chunk.

In the embodiment shown in FIG. 3, key value database 202 comprises a plurality of sender threads which send data chunks 206a, 206b, 206c, and 206c to the operation log management service 208, via a communication link. The communication link enables the key value database 202 to communicate (i.e. exchange data) with the decoupled operation log management service 208.

In the embodiment shown in FIG. 3, operation log management service 208 receives data chunks 206a, 206b, 206c, and 206c and reads these data chunks using multiple reader threads. In particular, each reader thread reads data chunks 206a, 206b, 206c, and 206c and writes the operation data specified therein to a merged data buffer 210.

The operations data in data chunks 206a, 206b, 206c, and 206c is also added to a hash table 214 to detect collisions. Hash table 214 forms part of the operation log management system. In the embodiment shown in FIG. 3, hash table 214 stores keys associated with values. In an embodiment, each value comprises a list of operations associated with operation data and a chunk-id associated with the data chunk from which the operation data was derived.

Operation log management system is capable of performing hash operations (i.e. hashing) using the key of a key-value pair in the hash table 214 to calculate a hash value, for example a unique index for each key-value pair in the hash table 214. In the event key-value pairs are hashed to the same index, the keys corresponding to the key-value pairs are added to a collision list 220. For example, as shown in FIG. 3, collisions have been detected with respect to key “a” 216 and key “b” 218. Accordingly, keys “a” and “b” have been added to collision list 220. In this example, “a” and “b” are simplified representation of the keys of key-value pairs.

In the embodiment shown in FIG. 3, after processing all the data chunks 206a, 206b, 206c, and 206c and generating hash table 214, all collisions are detected and the keys which have a collision are added to the collision list 220. The operation data associated with each key that has a collision is re-ordered in the merged data buffer 210. For example, this re-ordering can be accomplished by removing the operation data associated with a collision key from the merged data buffer 210 and then adding the operation data associated with a collision key back to the end of the merged data buffer 210 for processing. Alternatively, operation data associated with each key that has a collision may be moved to the end of the merged data buffer 210 for processing.

One or more operation log management service processors of the operation log management service 208 can process the operation data in the merged data buffer. For example, operation data associated with values of keys in the collision list 220 with the same index can be processed sequentially (i.e. by a single processing thread). If there are multiple keys with collisions, the operation data associated with keys having different collisions can be processed by different threads. In other words, operation data associated with key-value pairs having a different index can be processed by different processing threads. The processing threads of the operation log management service 208 may be the same threads as the reader threads of the operation log management service 208. Alternatively, the reader threads and processing threads of operation log management service 208 may be different threads.

In an embodiment, the operation data in the merged data buffer is processed by one or more operation log management service processors of the operation log management service 208 to generate operation information. After operation data has been processed, it can be flushed to the operation log 212. For example, operation data and associated operation information may be flushed to the operation log 212. Preferably, the flush frequency is user configurable.

In the event collisions are detected, the operation data associated with collision keys is re-ordered in the merged data buffer 210 and, therefore, the order of operation data in the operation log 212 is different than the order in which the operation data was received by the operation log management service 208.

The method of concurrently managing operation data disclosed in FIG. 3 may decrease latency and further improve the key-value database systems disclosed herein which make use of decoupled core and operation log management services. A decoupled operation log management service comprising multiple threads enables concurrently receiving and processing operation data which may result in improved performance of the operation log management service. Furthermore, an operation log management service can use multiple threads to enable faster replication of key-value databases.

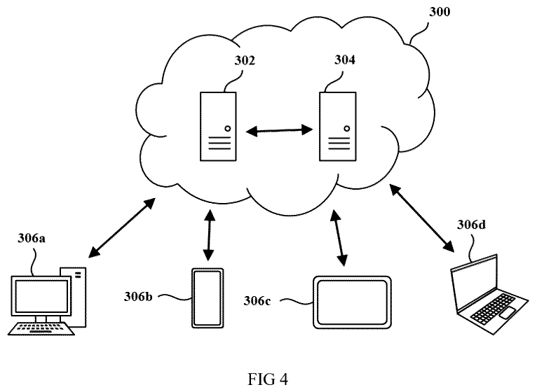

The invention will now be described with reference to FIG. 4 which shows a schematic diagram of a key-value database system 300 interacting with user devices 306a, 306b, 306c, 306d according to an embodiment of the invention.

As shown in FIG. 4, key-value database system 300 comprises hardware 302 for one or more key-value databases and hardware 304 for an operation log management system. In the exemplary described embodiment, hardware 302 comprises memory for storing data in key-value format in one or more key-value databases and one or more processors for executing logic performed by a core service on the one or more key-value databases. Hardware 304 comprises dedicated memory for storing an operation log and processors for executing logic performed by an operation log management service.

In the exemplary described embodiment, hardware 302 for one or more key-value databases is decoupled from hardware 304 for operation log management system.

The memories comprised within hardware 302 and hardware 304 may comprise read-only memory, cache memory, random access memory, virtual memory, or other types of memory. In another embodiment of the disclosed invention, hardware 302 and hardware 304 may share some resources. For example, the one or more key-value databases and decoupled operation log management system may share memory resources but have dedicated processors for operating the core service and operation log management service, respectively. In another embodiment, hardware 302 and hardware 304 share the resources of one or more partitioned processors. In embodiments using partitioned processors, the core service of the one or more key-value databases and operation log management service are still considered decoupled as each service uses a dedicated part of one or more shared processors.

According to an embodiment of the invention, key-value database system 300 is capable of performing any embodiment of the above-described methods. According to another embodiment of the invention, key-value database system 300 comprises non-transitory computer-readable storage media comprising computer-executable instructions, wherein the instructions, when executed, cause at least one processor to perform any embodiment of the above-described methods.

In the exemplary described embodiment, key-value database system 300 operates in a cloud environment. Hardware 302 and hardware 304 may be situated in different physical locations. In other embodiments, hardware 302 and hardware 304 may share resources and be situated in the same physical location. In other embodiments, key-value database system 300 need not necessarily operate in a cloud environment.

User devices such as a personal computer 306a, a smart phone 306b, a tablet 306c, a laptop computer 306d, and/or other types of user devices may interact with, access, and/or share data with key-value database system 300. The user devices may not necessarily require a human to command the user device to interact with key-value database system 300. User devices may selectively interact with or access memory forming part of hardware 302 for one or more key-value databases. Likewise, user devices may selectively interact with or access memory forming part of hardware 304 for operation log management system.

Throughout the specification, unless the context requires otherwise, the word “comprise” or variations such as “comprises” or “comprising”, will be understood as “including but not limited to”. The claims should not be construed to be limited to the specific embodiments described herein. Modifications and improvements may be made without departing from the scope of the invention.

1. A method of managing an operation log using a service that is decoupled from a first key-value database, the method comprising:
receiving operation data at the service from the first key-value database;
processing the operation data by the service thereby generating operation information; and
recording the operation data and the operation information to the operation log using the service.

2. The method of claim 1 wherein the service receives the operation data in the form of a plurality of data chunks.

3. The method of claim 1 wherein the first key-value database is a key-value store or a key-value cache.

4. The method of claim 1 wherein the first key-value database comprises a key-value store and a key-value cache.

5. The method of claim 1 further comprising the step of transmitting the operation data from the service to the first key-value database for restoring the first key-value database to a first point-in-time.

6. The method of claim 1, wherein the operation data is received by the service via a communication link using transmission control protocol, an application programming interface, or hypertext transfer protocol secure.

7. The method of claim 1, wherein the operation information includes metadata details of operations executed on key-value data stored within the first key-value database, including operation id, timestamp, version, cluster id, shard id, and slot id.

8. The method of claim 1, further comprising the step of executing compaction, compression, archive, or purge operations on the operation log using the service.

9. The method of claim 1 further comprising the step of storing the operation information at the service.

10. The method of claim 1, wherein the first key-value database is configured to communicate with a second key-value database.

11. The method of claim 10 further comprising the step of transmitting the operation data from the service to the second key-value database for restoring the second key-value database to a second point-in-time.

12. The method of claim 10, wherein the second key-value database is maintained as a backup of the first key-value database.

13. The method of claim 10, wherein the service comprises a unified interface for transmitting the operation data to the first key-value database and to the second key-value database to allow restoration of the first key-value database to a first point-in-time and to allow restoration of the second key-value database to a second point-in-time.

14. One or more non-transitory, computer-readable storage media comprising computer-executable instructions, wherein the instructions, when executed, cause at least one processing unit, at least one processor, or at least one circuit to perform the method of claim 1.

15. A system comprising one or more processors functionally connected to one or more memories storing instructions, and the one or more processors is configured to execute the instructions and cause the system to perform the method of claim 1.

16. One or more non-transitory, computer-readable storage media comprising computer-executable instructions, wherein the instructions, when executed, cause at least one processing unit, at least one processor, or at least one circuit to perform the method of claim 2.

17. A method of concurrently managing operation data using a service decoupled from a key-value database, the method comprising:
receiving operation data in the form of a plurality of data chunks at the service from the key-value database;
reading the data chunks at the service using a plurality of reader threads;
incorporating the operation data in each data chunk in a merged data buffer and into a hash table, the hash table comprising a plurality of key-value data pairs, each key-value data pair comprising a key, a value associated with at least part of the operation data, and a hash value;
recording, in a collision list, the associated key of a given key-value pair that has the same hash value as another key-value pair;
re-ordering the operation data associated with the value of each key in the collision list to the end of the merged data buffer;
processing the operation data in the merged data buffer, wherein the re-ordered operation data associated with key-value pairs having the same hash value is processed using a single processing thread, and wherein the processing generates operation information; and
recording the operation data and operation information to an operation log.

18. The method of claim 17, wherein the method further comprises the step of processing the re-ordered operation data associated with key-value pairs having different hash values using a plurality of processing threads.

19. One or more non-transitory, computer-readable storage media comprising computer-executable instructions, wherein the instructions, when executed, cause at least one processing unit, at least one processor, or at least one circuit to perform the method of claim 17.

20. A system comprising one or more processors functionally connected to one or more memories storing instructions, and the one or more processors is configured to execute the instructions and cause the system to perform the method of claim 17.
